(19) United States
(12) Patent Application Publication
(10) Pub. No.: US 2008/0286430 A1
(43) Pub. Date: Nov. 20, 2008

(54) Antioxidant for fats, oils and food

(76) Inventors: Raymond Seltzer, New City, NY (US); Ramanathan Ravichandran, Suffern, NY (US)

Correspondence Address: JoAnn Villamizar;Ciba Corporation/Patent Department, 540 White Plains Road, P.O. Box 2005, Tarrytown, NY, 10591, US

(21) Appl. No.: 12/221,005

(22) Filed: Jul. 30, 2008

Related U.S. Application Data
(62) Division of application No. 10/538,891, filed on Jun. 14, 2005.
(60) Provisional application No. 60/434,715, filed on Dec. 18, 2002.

(51) Int. Cl. A23L 1/03; C11B 5/00

(52) U.S. Cl. 426/544

(57) ABSTRACT

A combination of one or more compounds selected from the group consisting of 3-arylbenzofuranones, long chain N,N-dialkylhydroxylamines, substituted hydroxylamines, nitrones, and amine oxides are highly effective antioxidants for use with edible organic substances subject to deterioration by oxidation.

This application is a divisional of U.S. Ser. No. 10/538,891, filed Jun. 14, 2005, pending, which is a 371 application of PCT/EP/2003/50954, filed Dec. 8, 2003, which claims priority to U.S. Provisional Ser. No. 60/434,715, filed Dec. 18, 2002, all of which are herein incorporated by reference.

### BACKGROUND OF THE INVENTION

The invention relates to the stabilization of edible organic substances subject to deterioration by oxidation. Antioxidants are of great importance in edible fats and fatty oils such as fatty acid glycerides, and in foods made with edible fats and fatty oils. The antioxidants are used to prevent or alleviate oxidative rancidity which causes undesirable flavors and odors, destroys fat-soluble vitamins and essential fatty acids, and produces toxicological effects. A food antioxidant should not impart undesirable characteristics, such as unpleasant odor or discoloration and advantageously has good carry-through which is the ability to survive baking or frying operations and provide improved keeping quality in food prepared from the stabilized edible organic substances.

The art shows many methods of inhibiting lipid oxidation by adding fat-soluble antioxidants to the substrate. The art does not show the stabilization of fats, oils, fatty foods and ingredients of foods employing one or more antioxidants selected from the group consisting of 3-arylbenzofuranones, long chain N,N-dialkylhydroxylamines, substituted hydroxylamines, nitrones, and amine oxides as defined hereinafter.

Phenols are commonly employed as antioxidants to stabilize organic materials and substituted phenols have been found to have improved antioxidant effectiveness since the efficiency of the phenol group in terminating oxidation is affected by the nature of the ring substituents. Some known phenolic antioxidants are not suitable for use in food because they are toxic to higher forms of animal life. For example, p-aminophenol is highly toxic and is a skin irritant.

Several phenolics have been used as antioxidants in foodstuffs, including butylated hydroxytoluene (BHT) and butylated hydroxyanisole (BHA). Even these antioxidants are now being examined by regulatory agencies and consumer activists and these developments have urged the need to exploit new sources of antioxidants for use in food applications. Also propyl gallate (PG), t-butylhydroxyquinone (TBHQ), iso-ascorbic acid, chloro-iso-ascorbic acid and ascorbyl palmitate have been permitted for use in food applications.

Young, U.S. Pat. No. 2,654,722, discloses the use of acyl-p-aminophenols to stabilize solid organic materials, such as synthetic rubbers, which tend to deteriorate due to oxidation. The acyl substitutent in these antioxidants has at least three carbon atoms and can be employed as food stabilizers.

U.S. Pat. No. 3,492,349 to Doyle and Baxter discloses di-lower alkyl-alkoxy- and hydroxyacetanilides. The patent teaches that these compounds have analgesic and antipyretic properties and low toxicity. The compound of this patent of the formula

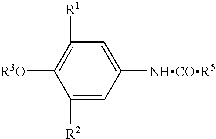

wherein R₃ is a hydrocarbon group may not have antioxidant activity since the effectiveness of p-aminophenols and other phenolics generally depends upon the presence of a free hydroxyl group, and the ethers and esters of these phenols generally have no significant effect.

U.S. Pat. No. 4,038,434 to Young discloses that certain N-acyl-2,6-dialkyl-p-aminophenols are highly effective antioxidants for use with edible organic substances.

U.S. Pat. No. 4,094,999 to Cohen and O'Connell discloses a food composition stabilized by the presence therein of a small proportion of a dialkyl pentaerythritol diphosphite.

U.S. Pat. No. 4,363,910 to Ambrus, Szabolesi and Hutas disclose the use of 2,2-dimethyl-1,2-dihydroquinoline derivatives useful as antioxidants to stabilize animal feedstuffs.

U.S. Pat. No. 5,084,289 to Shin, Han and Yi discloses a method for inhibiting the oxidation of edible oils and fats by forming a reverse miscelle by admixing a mixture of an aqueous solution containing tocopherol and ascorbic acid with a surfactant and said oils or fats.

U.S. Pat. No. 3,778,464 to Klemchuk discloses substituted hydroxylamine antioxidants of the formula R₇R₈NOH wherein R₇ or R₈ is alkyl containing from 1 to 3 carbon atoms, benzyl, chlorobenzyl, nitrobenzyl, benzhydryl or triephenylmethyl with the proviso that only one of R₇ or R₈ is alkyl and that R₈ is hydrogen when R₇ is benzhydryl or triphenylmethyl, or R₇ and R₈ taken together with the nitrogen atom form a heterocyclic group such as morpholino, piperidino or piperazino. The compounds are stated to be useful for organic substances including fats and oils of animal fats and foods made therewith or therein.

Other antioxidants for food include those disclosed in U.S. Pat. No. 5,527,552 to Todd, Jr.—green tea catechins; U.S. Pat. No. 4,925,681 to Mai, Chambers and McDonald—extracts from black tea.

It is an object of the invention to provide food compositions having improved stability and containing antioxidant compositions which include one or more of the antioxidants disclosed, herein.

It is a related object of this invention to provide a method of stabilizing food products through the addition thereto of antioxidant compositions which include one or more of the antioxidants of the present invention.

It is still another object of this invention to provide edible fat and oil compositions having improved stability and containing antioxidant compositions which include one or more of the antioxidants disclosed herein.

It is a still further object of this invention to provide a method of stabilizing edible fat and oil compositions through the addition thereto of antioxidant compositions which include one or more of the antioxidants of the present invention.

### SUMMARY OF THE INVENTION

It is has now been found that a combination of one or more compounds selected from the group consisting of 3-arylbenzofuranones, long chain N,N-dialkylhydroxylamines, substituted hydroxylamines, nitrones, and amine oxides as defined hereinafter are highly effective antioxidants for use with edible organic substances subject to deterioration by oxidation.

### DETAILED DESCRIPTION

Edible organic substances that may be stabilized against oxidation include hydrocarbon-containing substances that are suitable for human or animal consumption, for example, frying oils and fats, potato flakes, bakery products, meat emulsions, precooked cereals, instant noodles, soybean milk, chicken products, emulsion products such as sausage, mayonnaise and margarine, frozen fish, frozen pizza, cheese and animal foods.

The antioxidants of this invention are extremely useful in the stabilization of fats, fatty alcohols, fatty acids, esters of fatty acids and fatty oils which may be essentially solid or liquid at room temperature, and may be hydrogenated or unhydrogenated as well as various foods containing or prepared in such products. The oils or fats may be naturally-occurring, such as animal or vegetable fats, or synthetic materials. Exemplary materials are tallow, lard, peanut oil, corn oil, cottonseed oil, olive oil, safflower oil, soybean oil, coconut oil, shortening, cooking oils, salad oils and dressings, mayonnaise, margarine and the like. The fatty acid portion of such materials generally has at least about 12 carbon atoms, say up to about 24 or more carbon atoms per ester site, and the ester portions are frequently glycerides, although the materials may be other types of esters of various mono and polyhydroxy alkyl alcohols. Generally, the ester portions of the molecule have less than about 12 carbon atoms, preferably less than about 6 carbon atoms, e.g. glycerides or other lower alkyl esters.

The 3-arylbenzofuranones antioxidants of the present invention are for example those disclosed in U.S. Pat. Nos. 4,325,863; 4,388,244; 5,175,312; 5,252,643; 5,216,052; 5,369,159; 5,488,117; 5,356,966; 5,367,008; 5,428,162; 5,428,177; and 5,516,920; which are hereby incorporated by reference.

Particularly suitable 3-arylbenzofuranones in the present invention are compounds of the formula I

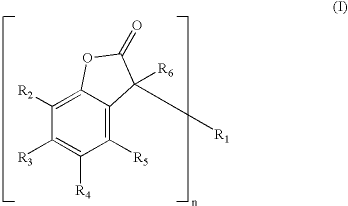

in which, if n is 1,
R₁ is unsubstituted or C₁-C₄alkyl-, C₁-C₄alkoxy-, C₁-C₄alkylthio-, hydroxyl-, halo-, amino-, C₁-C₄alkylamino-, phenylamino- or di(C₁-C₄alkyl)amino-substituted naphthyl, phenanthryl, anthryl, 5,6,7,8-tetrahydro-2-naphthyl, 5,6,7,8-tetrahydro-1-naphthyl, thienyl, benzo[b]thienyl, naphtho[2,3-b]thienyl, thianthrenyl, dibenzofuryl, chromenyl, xanthenyl, phenoxathiinyl, pyrrolyl, imidazolyl, pyrazolyl, pyrazinyl, pyrimidinyl, pyridazinyl, indolizinyl, isoindolyl, indolyl, indazolyl, purinyl, quinolizinyl, isoquinolyl, quinolyl, phthalazinyl, naphthyridinyl, quinoxalinyl, quinazolinyl, cinnolinyl, pteridinyl, carbazolyl, β-carbolinyl, phenanthridinyl, acridinyl, perimidinyl, phenanthrolinyl, phenazinyl, isothiazolyl, phenothiazinyl, isoxazolyl, furazanyl, biphenyl, terphenyl, fluorenyl or phenoxazinyl, or R₁ is a radical of the formula II

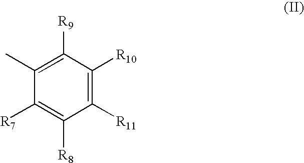

and
if n is 2,
R₁ is unsubstituted or C₁-C₄alkyl- or hydroxy-substituted phenylene or naphthylene; or is -R₁₂-X-R₁₃-,
R₂, R₃, R₄ and R₅ independently of one another are hydrogen, chlorine, hydroxyl, C₁-C₂₅alkyl, C₇-C₉phenylalkyl, unsubstituted or C₁-C₄alkyl-substituted phenyl; unsubstituted or C₁-C₄alkyl-substituted C₅-C₈cycloalkyl; C₁-C₁₈alkoxy, C₁-C₁₈alkylthio, C₁-C₄alkylamino, di(C₁-C₄alkyl)amino, C₁-C₂₅alkanoyloxy, C₁-C₂₅alkanoylamino, C₃-C₂₅alkenoyloxy, C₃-C₂₅alkanoyloxy which is interrupted by oxygen, sulfur or

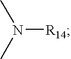

C₆-C₉cycloalkyl-carbonyloxy, benzoyloxy or C₁-C₁₂alkyl-substituted benzoyloxy; or else the radicals R₂ and R₃ or the radicals R₃ and R₄ or the radicals R₄ and R₅, together with the carbon atoms to which they are attached, form a benzo ring, R₄ is additionally —(CH₂)ₚ—COR₁₅ or —(CH₂)_{q}OH or, if R₃, R₅ and R₆ are hydrogen, R₄ is additionally a radical of the formula III

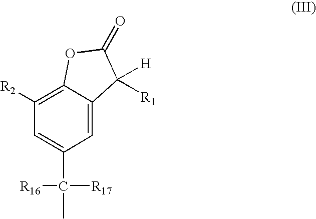

in which R₁ is defined as indicated above for n=1,
R₆ is hydrogen or a radical of the formula IV

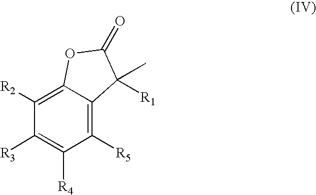

where R₄ is not a radical of the formula III and R₁ is defined as indicated above for n=1, R₇, R₈, R₉, R₁₀ and R₁₁ independently of one another are hydrogen, halogen, hydroxyl, C₁-C₂₅alkyl, C₂-C₂₅alkyl interrupted by oxygen, sulfur or

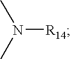

C₁-C₂₅alkoxy, C₂-C₂₅alkoxy interrupted by oxygen, sulfur or

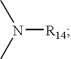

C₁-C₂₅alkylthio, C₃-C₂₅alkenyl, C₃-C₂₅alkenyloxy, C₃-C₂₅alkynyl, C₃-C₂₅alkynyloxy, C₇-C₉phenylalkyl, C₇-C₉phenylalkoxy, unsubstituted or C₁-C₄alkyl-substituted phenyl; unsubstituted or C₁-C₄alkyl-substituted phenoxy; unsubstituted or C₁-C₄alkyl-substituted C₅-C₈cycloalkyl; unsubstituted or C₁-C₄alkyl-substituted C₅-C₈cycloalkoxy; C₁-C₄alkylamino, di(C₁-C₄alkyl)amino, C₁-C₂₅alkanoyl, C₃-C₂₅alkanoyl interrupted by oxygen, sulfur or

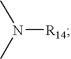

C₁-C₂₅alkanoyloxy, C₃-C₂₅alkanoyloxy interrupted by oxygen, sulfur or

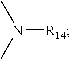

C₁-C₂₅alkanoylamino, C₃-C₂₅alkenoyl, C₃-C₂₅alkenoyl interrupted by oxygen, sulfur or

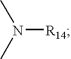

C₃-C₂₅alkenoyloxy, C₃-C₂₅alkenoyloxy interrupted by oxygen, sulfur or

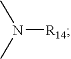

C₆-C₉cycloalkylcarbonyl, C₆-C₉cycloalkylcarbonyloxy, benzoyl or C₁-C₁₂alkyl-substituted benzoyl; benzoyloxy or C₁-C₁₂alkyl-substituted benzoyloxy;

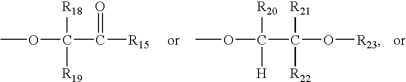

else, in formula II, the radicals R₇ and R₈ or the radicals R₈ and R₁₁, together with the carbon atoms to which they are attached, form a benzo ring,
R₁₂ and R₁₃ independently of one another are unsubstituted or C₁-C₄alkyl-substituted phenylene or naphthylene,
R₁₄ is hydrogen or C₁-C₈alkyl,
R₁₅ is hydroxyl,

$$[ - {o}^{-} \frac{1}{r} {M}^{r +} ] ,$$

C₁-C₁₈alkoxy or

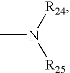

R₁₆ and R₁₇ independently of one another are hydrogen, CF₃, C₁-C₁₂alkyl or phenyl, or R₁₆ and R₁₇, together with the C atom to which they are attached, form a C₅-C₈cycloalkylidene ring which is unsubstituted or substituted from 1 to 3 times by C₁-C₄alkyl;
R₁₈ and R₁₉ independently of one another are hydrogen, C₁-C₄alkyl or phenyl,
R₂₀ is hydrogen or C₁-C₄alkyl,
R₂₁ is hydrogen, unsubstituted or C₁-C₄alkyl-substituted phenyl; C₁-C₂₅alkyl, C₂-C₂₅alkyl interrupted by oxygen, sulfur or

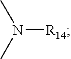

C₇-C₉phenylalkyl which is unsubstituted or substituted on the phenyl radical from 1 to 3 times by C₁-C₄alkyl; C₇-C₂₅phenylalkyl which is unsubstituted or substituted on the phenyl radical from 1 to 3 times by C₁-C₄alkyl and interrupted by oxygen, sulfur or

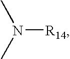

or else the radicals R₂₀ and R₂₁, together with the carbon atoms to which they are attached, form a C₅-C₁₂cycloalkylene ring which is unsubstituted or substituted from 1 to 3 times by C₁-C₄alkyl;
R₂₂ is hydrogen or C₁-C₄alkyl,
R₂₃ is hydrogen, C₁-C₂₅alkanoyl, C₃-C₂₅alkenoyl, C₃-C₂₅alkanoyl interrupted by oxygen, sulfur or

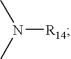

C₂-C₂₅alkanoyl substituted by a di(C₁-C₆alkyl)phosphonate group; C₆-C₉cycloalkylcarbonyl, thenoyl, furoyl, benzoyl or C₁-C₁₂alkyl-substituted benzoyl;

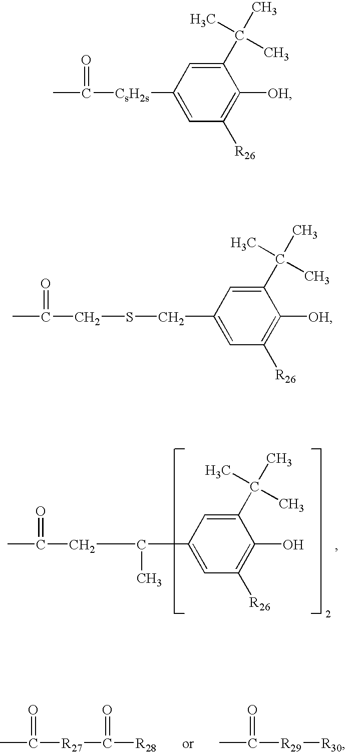

R₂₄ and R₂₅ independently of one another are hydrogen or C₁-C₁₈alkyl,
R₂₆ is hydrogen or C₁-C₈alkyl,

R₂₇ is a direct bond, C₁-C₁₈alkylene, C₂-C₁₈alkylene interrupted by oxygen, sulfur or

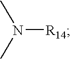

C₂-C₁₈alkenylene, C₂-C₂₀alkylidene, C₇-C₂₀phenylalkylidene, C₅-C₈cycloalkylene, C₇-C₈bicycloalkylene, unsubstituted or C₁-C₄alkyl-substituted phenylene, or

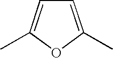

or

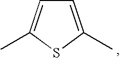

R₂₈ is hydroxyl,

$$[ - {o}^{-} \frac{1}{r} {M}^{r +} ] ,$$

C₁-C₁₈alkoxy or

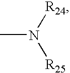

R₂₉ is oxygen, —NH— or

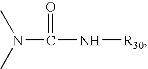

R₃₀ is C₁-C₁₈alkyl or phenyl,
R₃₁ is hydrogen or C₁-C₁₈alkyl,
M is an r-valent metal cation,
X is a direct bond, oxygen, sulfur or —NR₃₁—,
n is 1 or 2,
p is 0, 1 or 2,
q is 1, 2, 3, 4, 5 or 6,
r is 1, 2 or 3, and
s is 0, 1 or 2.

Unsubstituted or C₁-C₄alkyl-, C₁-C₄alkoxy-, C₁-C₄alkylthio-, hydroxyl-, halo-, amino-, C₁-C₄alkylamino-, phenylamino- or di(C₁-C₄alkyl)amino-substituted naphthyl, phenanthryl, anthryl, 5,6,7,8-tetrahydro-2-naphthyl, 5,6,7,8-tetrahydro-1-naphthyl, thienyl, benzo[b]thienyl, naphtho[2,3-b]thienyl, thianthrenyl, dibenzofuryl, chromenyl, xanthenyl, phenoxathiinyl, pyrrolyl, imidazolyl, pyrazolyl, pyrazinyl, pyrimidinyl, pyridazinyl, indolizinyl, isoindolyl, indolyl, indazolyl, purinyl, quinolizinyl, isoquinolyl, quinolyl, phthalazinyl, naphthyridinyl, quinoxalinyl, quinazolinyl, cinnolinyl, pteridinyl, carbazolyl, β-carbolinyl, phenanthridinyl, acridinyl, perimidinyl, phenanthrolinyl, phenazinyl, isothiazolyl, phenothiazinyl, isoxazolyl, furazanyl, biphenyl, terphenyl, fluorenyl or phenoxazinyl is, for example, 1-naphthyl, 2-naphthyl, 1-phenylamino-4-naphthyl, 1-methylnaphthyl, 2-methylnaphthyl, 1-methoxy-2-naphthyl, 2-methoxy-1-naphthyl, 1-dimethylamino-2-naphthyl, 1,2-dimethyl-4-naphthyl, 1,2-dimethyl-6-naphthyl, 1,2-dimethyl-7-naphthyl, 1,3-dimethyl-6-naphthyl, 1,4-dimethyl-6-naphthyl, 1,5-dimethyl-2-naphthyl, 1,6-dimethyl-2-naphthyl, 1-hydroxy-2-naphthyl, 2-hydroxy-1-naphthyl, 1,4-dihydroxy-2-naphthyl, 7-phenanthryl, 1-anthryl, 2-anthryl, 9-anthryl, 3-benzo[b]thienyl, 5-benzo[b]thienyl, 2-benzo[b]thienyl, 4-dibenzofuryl, 4,7-dibenzofuryl, 4-methyl-7-dibenzofuryl, 2-xanthenyl, 8-methyl-2-xanthenyl, 3-xanthenyl, 2-phenoxathiinyl, 2,7-phenoxathiinyl, 2-pyrrolyl, 3-pyrrolyl, 5-methyl-3-pyrrolyl, 2-imidazolyl, 4-imidazolyl, 5-imidazolyl, 2-methyl-4-imidazolyl, 2-ethyl-4-imidazolyl, 2-ethyl-5-imidazolyl, 3-pyrazolyl, 1-methyl-3-pyrazolyl, 1-propyl-4-pyrazolyl, 2-pyrazinyl, 5,6-dimethyl-2-pyrazinyl, 2-indolizinyl, 2-methyl-3-isoindolyl, 2-methyl-1-isoindolyl, 1-methyl-2-indolyl, 1-methyl-3-indolyl, 1,5-dimethyl-2-indolyl, 1-methyl-3-indazolyl, 2,7-dimethyl-8-purinyl, 2-methoxy-7-methyl-8-purinyl, 2-quinolizinyl, 3-isoquinolyl, 6-isoquinolyl, 7-isoquinolyl, isoquinolyl, 3-methoxy-6-isoquinolyl, 2-quinolyl, 6-quinolyl, 7-quinolyl, 2-methoxy-3-quinolyl, 2-methoxy-6-quinolyl, 6-phthalazinyl, 7-phthalazinyl, 1-methoxy-6-phthalazinyl, 1,4-dimethoxy-6-phthalazinyl, 1,8-naphthyridin-2-yl, 2-quinoxalinyl, 6-quinoxalinyl, 2,3-dimethyl-6-quinoxalinyl, 2,3-dimethoxy-6-quinoxalinyl, 2-quinazolinyl, 7-quinazolinyl, 2-dimethylamino-6-quinazolinyl, 3-cinnolinyl, 6-cinnolinyl, 7-cinnolinyl, 3-methoxy-7-cinnolinyl, 2-pteridinyl, 6-pteridinyl, 7-pteridinyl, 6,7-dimethoxy-2-pteridinyl, 2-carbazolyl, 3-carbazolyl, 9-methyl-2-carbazolyl, 9-methyl-3-carbazolyl, β-carbolin-3-yl, 1-methyl-β-carbolin-3-yl, 1-methyl-β-carbolin-6-yl, 3-phenanthridinyl, 2-acridinyl, 3-acridinyl, 2-perimidinyl, 1-methyl-5-perimidinyl, 5-phenanthrolinyl, 6-phenanthrolinyl, 1-phenazinyl, 2-phenazinyl, 3-isothiazolyl, 4-isothiazolyl, 5-isothiazolyl, 2-phenothiazinyl, 3-phenothiazinyl, 10-methyl-3-phenothiazinyl, 3-isoxazolyl, 4-isoxazolyl, 5-isoxazolyl, 4-methyl-3-furazanyl, 2-phenoxazinyl or 10-methyl-2-phenoxazinyl.

Particular preference is given to unsubstituted or C₁-C₄alkyl-, C₁-C₄alkoxy-, C₁-C₄alkylthio-, hydroxyl-, phenylamino- or di(C₁-C₄alkyl)amino-substituted naphthyl, phenanthryl, anthryl, 5,6,7,8-tetrahydro-2-naphthyl, 5,6,7,8-tetrahydro-1-naphthyl, thienyl, benzo[b]thienyl, naphtho[2,3-b]thienyl, thianthrenyl, dibenzofuryl, chromenyl, xanthenyl, phenoxathiinyl, pyrrolyl, isoindolyl, indolyl, phenothiazinyl, biphenyl, terphenyl, fluorenyl or phenoxazinyl such as, for example, 1-naphthyl, 2-naphthyl, 1-phenylamino-4-naphthyl, 1-methylnaphthyl, 2-methyl-naphthyl, 1-methoxy-2-naphthyl, 2-methoxy-1-naphthyl, 1-dimethylamino-2-naphthyl, 1,2-dimethyl-4-naphthyl, 1,2-dimethyl-6-naphthyl, 1,2-dimethyl-7-naphthyl, 1,3-dimethyl-6-naphthyl, 1,4-dimethyl-6-naphthyl, 1,5-dimethyl-2-naphthyl, 1,6-dimethyl-2-naphthyl, 1-hydroxy-2-naphthyl, 2-hydroxy-1-naphthyl, 1,4-dihydroxy-2-naphthyl, 7-phenanthryl, 1-anthryl, 2-anthryl, 9-anthryl, 3-benzo[b]thienyl, 5-benzo[b]thienyl, 2-benzo[b]thienyl, 4-dibenzofuryl, 4,7-dibenzofuryl, 4-methyl-7-dibenzofuryl, 2-xanthenyl, 8-methyl-2-xanthenyl, 3-xanthenyl, 2-pyrrolyl, 3-pyrrolyl, 2-phenothiazinyl, 3-phenothiazinyl, 10-methyl-3-phenothiazinyl.

Halogen (halo) is, for example, chlorine, bromine or iodine. Preference is given to chlorine.

Alkanoyl having up to 25 carbon atoms is a branched or unbranched radical such as, for example, formyl, acetyl, propionyl, butanoyl, pentanoyl, hexanoyl, heptanoyl, octanoyl, nonanoyl, decanoyl, undecanoyl, dodecanoyl, tridecanoyl, tetradecanoyl, pentadecanoyl, hexadecanoyl, heptadecanoyl, octadecanoyl, eicosanoyl or docosanoyl. Preference is given to alkanoyl having 2 to 18, especially 2 to 12, for example 2 to 6 carbon atoms. Particular preference is given to acetyl.

C₂-C₂₅alkanoyl substituted by a di(C₁-C₆alkyl)phosphonate group is, for example, (CH₃CH₂O)₂POCH₂CO—, (CH₃O)₂POCH₂CO—, (CH₃CH₂CH₂CH₂O)₂POCH₂CO—, (CH₃CH₂O)₂POCH₂CH₂CO—, (CH₃O)₂POCH₂CH₂CO—, (CH₃CH₂CH₂CH₂O)₂POCH₂CH₂CO—, (CH₃CH₂O)₂PO(CH₂)₄CO—, (CH₃CH₂O)₂PO(CH₂)₈CO— or (CH₃CH₂O)₂PO(CH₂)₁₇CO—.

Alkanoyloxy having up to 25 carbon atoms is a branched or unbranched radical such as, for example, formyloxy, acetoxy, propionyloxy, butanoyloxy, pentanoyloxy, hexanoyloxy, heptanoyloxy, octanoyloxy, nonanoyloxy, decanoyloxy, undecanoyloxy, dodecanoyloxy, tridecanoyloxy, tetradecanoyloxy, pentadecanoyloxy, hexadecanoyloxy, heptadecanoyloxy, octadecanoyloxy, eicosanoyloxy or docosanoyloxy. Preference is given to alkanoyloxy having 2 to 18, especially 2 to 12, for example 2 to 6 carbon atoms. Particular preference is given to acetoxy.

Alkenoyl having 3 to 25 carbon atoms is a branched or unbranched radical such as, for example, propenoyl, 2-butenoyl, 3-butenoyl, isobutenoyl, n-2,4-pentadienoyl, 3-methyl-2-butenoyl, n-2-octenoyl, n-2-dodecenoyl, iso-dodecenoyl, oleoyl, n-2-octadecenoyl or n-4-octadecenoyl. Preference is given to alkenoyl having 3 to 18, especially 3 to 12, for example 3 to 6, in particular 3 to 4 carbon atoms.

C₃-C₂₅alkenoyl interrupted by oxygen, sulfur or

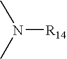

is, for example, CH₃OCH₂CH₂CH═CHCO— or CH₃OCH₂CH₂OCH═CHCO—.

Alkenoyloxy having 3 to 25 carbon atoms is a branched or unbranched radical such as, for example, propenoyloxy, 2-butenoyloxy, 3-butenoyloxy, isobutenoyloxy, n-2,4-pentadienoyloxy, 3-methyl-2-butenoyloxy, n-2-octenoyloxy, n-2-dodecenoyloxy, iso-dodecenoyloxy, oleoyloxy, n-2-octadecenoyloxy or n-4-octadecenoyloxy. Preference is given to alkenoyloxy having 3 to 18, especially 3 to 12, for example 3 to 6, in particular 3 to 4 carbon atoms.

C₃-C₂₅alkenoyloxy interrupted by oxygen, sulfur or

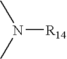

is, for example, CH₃OCH₂CH₂CH═CHCOO— or CH₃OCH₂CH₂OCH═CHCOO—.

C₃-C₂₅alkanoyl interrupted by oxygen, sulfur or

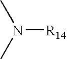

is, for example, CH₃—O—CH₂CO—CH₃—S—CH₂CO—, CH₃—NH—CH₂CO—, CH₃—N(CH₃)—CH₂CO—, CH₃—O—CH₂CH₂—O—CH₂CO—, CH₃—(O—CH₂CH₂—)₂O—CH₂CO—, CH₃—(O—CH₂CH₂—)₃O—CH₂CO— or CH₃—(O—CH₂CH₂—)₄O—CH₂CO—.

C₃-C₂₅alkanoyloxy interrupted by oxygen, sulfur or

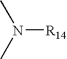

is, for example, CH₃—O—CH₂COO—, CH₃—S—CH₂COO—, CH₃—NH—CH₂COO—, CH₃—N(CH₃)—CH₂COO—, CH₃—O—CH₂CH₂—O—CH₂COO—, CH₃—(O—CH₂CH₂—)₂O—CH₂COO—, CH₃—(O—CH₂CH₂—)₃O—CH₂COO— or CH₃—(O—CH₂CH₂—)₄O—CH₂COO—.

C₆-C₉cycloalkylcarbonyl is, for example, cyclopentylcarbonyl, cyclohexylcarbonyl, cycloheptylcarbonyl or cyclooctylcarbonyl. Cyclohexylcarbonyl is preferred.

C₆-C₉cycloalkylcarbonyloxy is, for example, cyclopentylcarbonyloxy, cyclohexylcarbonyloxy, cycloheptylcarbonyloxy or cyclooctylcarbonyloxy. Cyclohexylcarbonyloxy is preferred.

C₁-C₁₂alkyl-substituted benzoyl, which preferably carries 1 to 3, especially 1 or 2 alkyl groups, is, for example, o-, m- or p-methylbenzoyl, 2,3-dimethylbenzoyl, 2,4-dimethylbenzoyl, 2,5-dimethylbenzoyl, 2,6-dimethylbenzoyl, 3,4-dimethylbenzoyl, 3,5-dimethylbenzoyl, 2-methyl-6-ethylbenzoyl, 4-tert-butylbenzoyl, 2-ethylbenzoyl, 2,4,6-trimethylbenzoyl, 2,6-dimethyl-4-tert-butylbenzoyl or 3,5-di-tert-butylbenzoyl. Preferred substituents are C₁-C₈alkyl, especially C₁-C₄alkyl.

C₁-C₁₂alkyl-substituted benzoyloxy, which preferably carries 1 to 3, especially 1 or 2 alkyl groups, is, for example, o-, m- or p-methylbenzoyloxy, 2,3-dimethylbenzoyloxy, 2,4-dimethylbenzoyloxy, 2,5-dimethylbenzoyloxy, 2,6-dimethylbenzoyloxy, 3,4-dimethylbenzoyloxy, 3,5-dimethylbenzoyloxy, 2-methyl-6-ethylbenzoyloxy, 4-tert-butylbenzoyloxy, 2-ethyl-benzoyloxy, 2,4,6-trimethylbenzoyloxy, 2,6-dimethyl-4-tert-butylbenzoyloxy or 3,5-di-tert-butylbenzoyloxy. Preferred substituents are C₁-C₈alkyl, especially C₁-C₄alkyl.

Alkyl having up to 25 carbon atoms is a branched or unbranched radical such as, for example, methyl, ethyl, propyl, isopropyl, n-butyl, sec-butyl, isobutyl, tert-butyl, 2-ethylbutyl, n-pentyl, isopentyl, 1-methylpentyl, 1,3-dimethylbutyl, n-hexyl, 1-methylhexyl, n-heptyl, isoheptyl, 1,1,3,3-tetramethylbutyl, 1-methylheptyl, 3-methylheptyl, n-octyl, 2-ethylhexyl, 1,1,3-trimethylhexyl, 1,1,3,3-tetramethylpentyl, nonyl, decyl, undecyl, 1-methylundecyl, dodecyl, 1,1,3,3,5,5-hexamethylhexyl, tridecyl, tetradecyl, pentadecyl, hexadecyl, heptadecyl, octadecyl, eicosyl or docosyl. One of the preferred meanings of R₂ and R₄ is, for example, C₁-C₁₈alkyl. A particularly preferred meaning of R₄ is C₁-C₄alkyl.

Alkenyl having 3 to 25 carbon atoms is a branched or unbranched radical such as, for example, propenyl, 2-butenyl, 3-butenyl, isobutenyl, n-2,4-pentadienyl, 3-methyl-2-butenyl, n-2-octenyl, n-2-dodecenyl, iso-dodecenyl, oleyl, n-2-octadecenyl or n-4-octadecenyl. Preference is given to alkenyl having 3 to 18, especially 3 to 12, for example 3 to 6, in particular 3 to 4 carbon atoms.

Alkenyloxy having 3 to 25 carbon atoms is a branched or unbranched radical such as, for example, propenyloxy, 2-butenyloxy, 3-butenyloxy, isobutenyloxy, n-2,4-pentadienyloxy, 3-methyl-2-butenyloxy, n-2-octenyloxy, n-2-dodecenyloxy, iso-dodecenyloxy, oleyloxy, n-2-octadecenyloxy or n-4-octadecenyloxy. Preference is given to alkenyloxy having 3 to 18, especially 3 to 12, for example 3 to 6, in particular 3 to 4 carbon atoms.

Alkynyl having 3 to 25 carbon atoms is a branched or unbranched radical such as, for example, propynyl

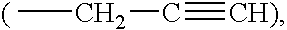

2-butynyl, 3-butynyl, n-2-octynyl, or n-2-dodecynyl. Preference is given to alkynyl having 3 to 18, especially 3 to 12, for example 3 to 6, in particular 3 to 4 carbon atoms.

Alkynyloxy having 3 to 25 carbon atoms is a branched or unbranched radical such as, for example, propynyloxy

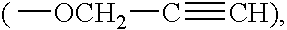

2-butynyloxy, 3-butynyloxy, n-2-octynyloxy, or n-2-dodecynyloxy. Preference is given to alkynyloxy having 3 to 18, especially 3 to 12, for example 3 to 6, in particular 3 to 4 carbon atoms.

C₂-C₂₅alkyl interrupted by oxygen, sulfur or

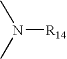

is, for example, CH₃—O—CH₂—, CH₃—S—CH₂—, CH₃—NH—CH₂—, CH₃—N(CH₃)—CH₂—, CH₃—O—CH₂CH₂—O—CH₂—, CH₃—(O—CH₂CH₂—)₂O—CH₂—, CH₃—(O—CH₂CH₂—)₃O—CH₂— or CH₃—(O—CH₂CH₂—)₄O—CH₂—.

C₇-C₉phenylalkyl is, for example, benzyl, α-methylbenzyl, α,α-dimethylbenzyl or 2-phenylethyl. Benzyl and α,α-dimethylbenzyl are preferred.

C₇-C₉phenylalkyl which is unsubstituted or substituted on the phenyl radical from 1 to 3 times by C₁-C₄alkyl is, for example, benzyl, α-methylbenzyl, α,α-dimethylbenzyl, 2-phenylethyl, 2-methylbenzyl, 3-methylbenzyl, 4-methylbenzyl, 2,4-dimethylbenzyl, 2,6-dimethylbenzyl or 4-tert-butylbenzyl. Benzyl is preferred.

C₇-C₂₅phenylalkyl which is unsubstituted or substituted on the phenyl radical from 1 to 3 times by C₁-C₄alkyl and is interrupted by oxygen, sulfur or

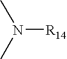

is a branched or unbranched radical such as, for example, phenoxymethyl, 2-methylphenoxymethyl, 3-methylphenoxymethyl, 4-methylphenoxymethyl, 2,4-dimethylphenoxymethyl, 2,3-dimethylphenoxymethyl, phenylthiomethyl, N-methyl-N-phenylmethyl, N-ethyl-N-phenylmethyl, 4-tert-butylphenoxymethyl, 4-tert-butylphenoxyethoxymethyl, 2,4-di-tert-butylphenoxymethyl, 2,4-di-tert-butylphenoxyethoxymethyl, phenoxyethoxyethoxyethoxymethyl, benzyloxymethyl, benzyloxyethoxymethyl, N-benzyl-N-ethylmethyl or N-benzyl-N-isopropylmethyl.

C₇-C₉phenylalkoxy is, for example, benzyloxy, α-methylbenzyloxy, α,α-dimethylbenzyloxy or 2-phenylethoxy. Benzyloxy is preferred.

C₁-C₄alkyl-substituted phenyl, which preferably contains 1 to 3, especially 1 or 2 alkyl groups, is, for example, o-, m- or p-methylphenyl, 2,3-dimethylphenyl, 2,4-dimethylphenyl, 2,5-dimethylphenyl, 2,6-dimethylphenyl, 3,4-dimethylphenyl, 3,5-dimethylphenyl, 2-methyl-6-ethylphenyl, 4-tert-butylphenyl, 2-ethylphenyl or 2,6-diethylphenyl.

C₁-C₄alkyl-substituted phenoxy, which preferably contains 1 to 3, especially 1 or 2 alkyl groups, is, for example, o-, m- or p-methylphenoxy, 2,3-dimethylphenoxy, 2,4-dimethylphenoxy, 2,5-dimethylphenoxy, 2,6-dimethylphenoxy, 3,4-dimethylphenoxy, 3,5-dimethylphenoxy, 2-methyl-6-ethylphenoxy, 4-tert-butylphenoxy, 2-ethylphenoxy or 2,6-diethylphenoxy.

Unsubstituted or C₁-C₄alkyl-substituted C₅-C₈cycloalkyl is, for example, cyclopentyl, methylcyclopentyl, dimethylcyclopentyl, cyclohexyl, methylcyclohexyl, dimethylcyclohexyl, trimethylcyclohexyl, tert-butylcyclohexyl, cycloheptyl or cyclooctyl. Preference is given to cyclohexyl and tert-butylcyclohexyl.

Unsubstituted or C₁-C₄alkyl-substituted C₅-C₈cycloalkoxy is, for example, cyclopentoxy, methylcyclopentoxy, dimethylcyclopentoxy, cyclohexoxy, methylcyclohexoxy, dimethylcyclohexoxy, trimethylcyclohexoxy, tert-butylcyclohexoxy, cycloheptoxy or cyclooctoxy. Preference is given to cyclohexoxy and tert-butylcyclohexoxy.

Alkoxy having up to 25 carbon atoms is a branched or unbranched radical such as, for example, methoxy, ethoxy, propoxy, isopropoxy, n-butoxy, isobutoxy, pentoxy, isopentoxy, hexoxy, heptoxy, octoxy, decyloxy, tetradecyloxy, hexadecyloxy or octadecyloxy. Preference is given to alkoxy having 1 to 12, especially 1 to 8, for example 1 to 6 carbon atoms.

C₂-C₂₅alkoxy interrupted by oxygen, sulfur or

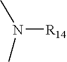

is, for example, CH₃—O—CH₂CH₂O—, CH₃—S—CH₂CH₂O—, CH₃—NH—CH₂CH₂O—, CH₃—N(CH₃)—CH₂CH₂O—, CH₃—O—CH₂CH₂—O—CH₂CH₂O—, CH₃—(O—CH₂CH₂—)₂O—CH₂CH₂O—, CH₃—(O—CH₂CH₂—)₃O—CH₂CH₂O— or CH₃—(O—CH₂CH₂—)₄O—CH₂CH₂O—.

Alkylthio having up to 25 carbon atoms is a branched or unbranched radical such as, for example, methylthio, ethylthio, propylthio, isopropylthio, n-butylthio, isobutylthio, pentylthio, isopentylthio, hexylthio, heptylthio, octylthio, decylthio, tetradecylthio, hexadecylthio or octadecylthio. Preference is given to alkylthio having 1 to 12, especially 1 to 8, for example 1 to 6 carbon atoms.

Alkylamino having up to 4 carbon atoms is a branched or unbranched radical such as, for example, methylamino, ethylamino, propylamino, isopropylamino, n-butylamino, isobutylamino or tert-butylamino.

Di(C₁-C₄alkyl)amino also means that the two radicals independently of one another are branched or unbranched, such as, for example, dimethylamino, methylethylamino, diethylamino, methyl-n-propylamino, methylisopropylamino, methyl-n-butylamino, methylisobutylamino, ethylisopropylamino, ethyl-n-butylamino, ethylisobutylamino, ethyl-tert-butylamino, diethylamino, diisopropylamino, isopropyl-n-butylamino, isopropylisobutylamino, di-n-butylamino or diisobutylamino.

Alkanoylamino having up to 25 carbon atoms is a branched or unbranched radical such as, for example, formylamino, acetylamino, propionylamino, butanoylamino, pentanoylamino, hexanoylamino, heptanoylamino, octanoylamino, nonanoylamino, decanoylamino, undecanoylamino, dodecanoylamino, tridecanoylamino, tetradecanoylamino, pentadecanoylamino, hexadecanoylamino, heptadecanoylamino, octadecanoylamino, eicosanoylamino or docosanoylamino. Preference is given to alkanoylamino having 2 to 18, especially 2 to 12, for example 2 to 6 carbon atoms.

C₁-C₁₈alkylene is a branched or unbranched radical such as, for example, methylene, ethylene, propylene, trimethylene, tetramethylene, pentamethylene, hexamethylene, heptamethylene, octamethylene, decamethylene, dodecamethylene or octadecamethylene. Preference is given to C₁-C₁₂alkylene, especially C₁-C₈alkylene.

A C₁-C₄alkyl-substituted C₅-C₁₂cycloalkylene ring, which preferably contains 1 to 3, especially 1 or 2 branched or unbranched alkyl group radicals is, for example, cyclopentylene, methylcyclopentylene, dimethylcyclopentylene, cyclohexylene, methylcyclohexylene, dimethylcyclohexylene, trimethylcyclohexylene, tertbutylcyclohexylene, cycloheptylene, cyclooctylene or cyclodecylene. Preference is given to cyclohexylene and tertbutylcyclohexylene.

C₂-C₁₈alkylene interrupted by oxygen, sulfur or

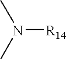

is, for example, —CH₂—O—CH₂—, —CH₂—S—CH₂—, —CH₂—NH—CH₂—, —CH₂—N(CH₃)—CH₂—, —CH₂—O—CH₂CH₂—O—CH₂—, —CH₂—(O—CH₂CH₂—)₂O—CH₂—, —CH₂—(O—CH₂CH₂—)₃O—CH₂—, —CH₂—(O—CH₂CH₂—)₄O—CH₂— or —CH₂CH₂—S—CH₂CH₂—.

C₂-C₁₈alkenylene is, for example, vinylene, methylvinylene, octenylethylene or dodecenylethylene. Preference is given to C₂-C₈alkenylene.

Alkylidene having 2 to 20 carbon atoms is, for example, ethylidene, propylidene, butylidene, pentylidene, 4-methylpentylidene, heptylidene, nonylidene, tridecylidene, nonadecylidene, 1-methylethylidene, 1-ethylpropylidene or 1-ethylpentylidene. Preference is given to C₂-C₈-alkylidene.

Phenylalkylidene having 7 to 20 carbon atoms is, for example, benzylidene, 2-phenylethylidene or 1-phenyl-2-hexylidene. Preference is given to C₇-C₉-phenylalkylidene.

C₅-C₈cycloalkylene is a saturated hydrocarbon group having two free valencies and at least one ring unit and is, for example, cyclopentylene, cyclohexylene, cycloheptylene or cyclooctylene. Preference is given to cyclohexylene.

C₇-C₈bicycloalkylene is, for example, bicycloheptylene or bicyclooctylene.

Unsubstituted or C₁-C₄alkyl-substituted phenylene or naphthylene is, for example, 1,2-, 1,3-, 1,4-phenylene, 1,2-, 1,3-, 1,4-, 1,6-, 1,7-, 2,6- or 2,7-naphthylene. 1,4-Phenylene is preferred.

A C₁-C₄alkyl-substituted C₅-C₈cycloalkylidene ring, which preferably contains 1 to 3, especially 1 or 2 branched or unbranched alkyl group radicals is, for example, cyclopentylidene, methylcyclopentylidene, dimethylcyclopentylidene, cyclohexylidene, methylcyclohexylidene, dimethylcyclohexylidene, trimethylcyclohexylidene, tert-butylcyclohexylidene, cycloheptylidene or cyclooctylidene. Preference is given to cyclohexylidene and tert-butylcyclohexylidene.

A mono-, di- or trivalent metal cation is preferably an alkali metal, alkaline earth metal or aluminium cation, for example, Na⁺, K⁺, Mg⁺⁺, Ca⁺⁺ or Al⁺⁺⁺.

A particularly preferred composition of present invention contains at least one compound of formula I, wherein, if n=1, R₁ is phenyl which is unsubstituted or substituted in para-position by C₁-C₁₈alkylthio or di(C₁-C₄alkyl)amino; mono- to penta-substituted alkyphenyl containing together a total of at most 18 carbon atoms in the 1 to 5 alkyl substituents; naphthyl, biphenyl, terphenyl, phenanthryl, anthryl, fluorenyl, carbazolyl, thienyl, pyrrolyl, phenothizinyl or 5,6,7,8-tetrahydronaphthyl, each of which is unsubstituted or substituted by C₁-C₄alkyl, C₁-C₄alkoxy, C₁-C₄alkylthio, hydroxy or amino.

Preference is given to compounds of the formula I in which, if n is 2,

### R₁ is -R₁₂-X-R₁₃-,

R₁₂ and R₁₃ are phenylene,
X is oxygen or —NR₃₁—, and
R₃₁ is C₁-C₄alkyl.

Preference is also given to compounds of the formula I in which, if n is 1, R₁ is unsubstituted or C₁-C₄alkyl-, C₁-C₄alkoxy-, C₁-C₄alkylthio-, hydroxyl-, halo-, amino-, C₁-C₄alkylamino- or di(C₁-C₄-alkyl)amino-substituted naphthyl, phenanthryl, thienyl, dibenzofuryl, carbazolyl, fluorenyl or a radical of the formula II

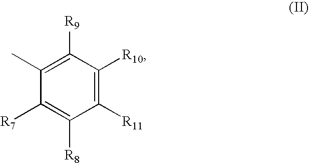

R₇, R₈, R₉, R₁₀ and R₁₁ independently of one another are hydrogen, chlorine, bromine, hydroxyl, C₁-C₁₈alkyl, C₂-C₁₈alkyl interrupted by oxygen or sulfur; C₁-C₁₈alkoxy, C₂-C₁₈alkoxy interrupted by oxygen or sulfur; C₁-C₁₈alkylthio, C₃-C₁₂alkenyloxy, C₃-C₁₂alkynyloxy, C₇-C₉phenylalkyl, C₇-C₉phenylalkoxy, unsubstituted or C₁-C₄alkyl-substituted phenyl; phenoxy, cyclohexyl, C₅-C₈cycloalkoxy, C₁-C₄alkylamino, di(C₁-C₄-alkyl)amino, C₁-C₁₂alkanoyl, C₃-C₁₂alkanoyl interrupted by oxygen or sulfur; C₁-C₁₂alkanoyloxy, C₃-C₁₂alkanoyloxy interrupted by oxygen or sulfur; C₁-C₁₂alkanoylamino, C₃-C₁₂alkenoyl, C₃-C₁₂alkenoyloxy, cyclohexylcarbonyl, cyclohexylcarbonyloxy, benzoyl or C₁-C₄alkyl-substituted benzoyl; benzoyloxy or C₁-C₄alkyl-substituted benzoyloxy;

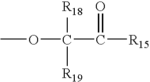

or

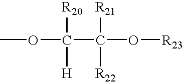

or else in formula II the radicals R₇ and R₈ or the radicals R₈ and R₁₁, together with the carbon atoms to which they are attached, form a benzo ring, R₁₅ is hydroxyl, C₁-C₁₂alkoxy or

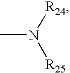

R₁₈ and R₁₉ independently of one another are hydrogen or C₁-C₄alkyl,
R₂₀ is hydrogen,
R₂₁ is hydrogen, phenyl, C₁-C₁₈alkyl, C₂-C₁₈alkyl interrupted by oxygen or sulfur; C₇-C₉phenylalkyl, C₇-C₁₈-phenylalkyl which is unsubstituted or substituted on the phenyl radical from 1 to 3 times by C₁-C₄alkyl and is interrupted by oxygen or sulfur, or else the radicals R₂₀ and R₂₁, together with the carbon atoms to which they are attached, form a cyclohexylene ring which is unsubstituted or substituted from 1 to 3 times by C₁-C₄alkyl,
R₂₂ is hydrogen or C₁-C₄alkyl,
R₂₃ is hydrogen, C₁-C₁₈alkanoyl, C₃-C₁₈alkenoyl, C₃-C₁₂alkanoyl interrupted by oxygen or sulfur; C₂-C₁₂alkanoyl substituted by a di(C₁-C₆-alkyl)phosphonate group; C₆-C₉cycloalkylcarbonyl, benzoyl,

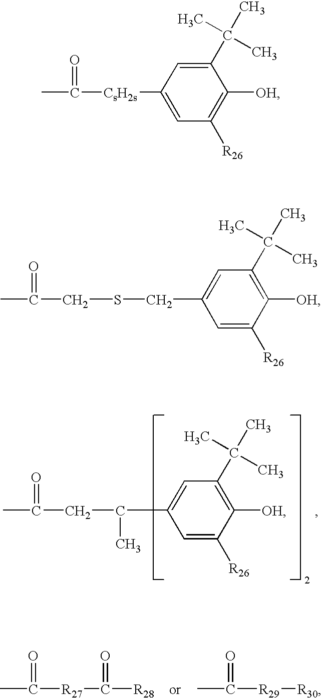

R₂₄ and R₂₅ independently of one another are hydrogen or C₁-C₁₂alkyl,
R₂₆ is hydrogen or C₁-C₄alkyl,
R₂₇ is C₁-C₁₂alkylene, C₂-C₈alkenylene, C₂-C₈alkylidene, C₇-C₁₂phenylalkylidene, C₅-C₈cycloalkylene or phenylene,
R₂₈ is hydroxyl, C₁-C₁₂alkoxy or

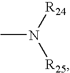

R₂₉ is oxygen or —NH—,
R₃₀ is C₁-C₁₈alkyl or phenyl, and
s is 1 or 2.

Preference is likewise given to compounds of the formula I in which, if n is 1,

R₁ is phenanthryl, thienyl, dibenzofuryl, unsubstituted or C₁-C₄alkyl-substituted carbazolyl; or is fluorenyl; or R₁ is a radical of the formula II

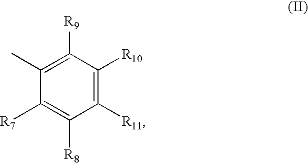

R₇, R₈, R₉, R₁₀ and R₁₁, independently of one another are hydrogen, chlorine, hydroxyl, C₁-C₁₈alkyl, C₁-C₁₈alkoxy, C₁-C₁₈alkylthio, C₃-C₄alkenyloxy, C₃-C₄alkinyloxy, C₂-C₁₈alkanoyloxy, phenyl, benzoyl, benzoyloxy or

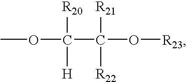

R₂₀ is hydrogen,
R₂₁ is hydrogen, phenyl or C₁-C₁₈alkyl, or else the radicals R₂₀ and R₂₁, together with the carbon atoms to which they are attached, form a cyclohexylene ring which is unsubstituted or substituted from 1 to 3 times by C₁-C₄alkyl,
R₂₂ is hydrogen or C₁-C₄alkyl, and
R₂₃ is hydrogen, C₁-C₁₈alkanoyl or benzoyl.

Particular preference is given to compounds of the formula I in which, if n is 1, R₇, R₈, R₉, R₁₀ and R₁₁ independently of one another are hydrogen, C₁-C₄alkylthio or phenyl.

Of particular interest is a composition containing at least one compound of the formula I in which

R₂, R₃, R₄ and R₅ independently of one another are hydrogen, chlorine, C₁-C₁₈alkyl, benzyl, phenyl, C₅-C₈cycloalkyl, C₁-C₁₈alkoxy, C₁-C₁₈alkylthio, C₁-C₁₈alkanoyloxy, C₁-C₁₈alkanoylamino, C₃-C₁₈alkenoyloxy or benzoyloxy; or else the radicals R₂ and R₃ or the radicals R₃ and R₄ or the radicals R₄ and R₅, together with the carbon atoms to which they are attached, form a benzo ring, R₄ is additionally —(CH₂)ₚ—COR₁₅ or —(CH₂)_{q}OH, or, if R₃, R₅ and R₆ are hydrogen, R₄ is additionally a radical of the formula III,
R₁₅ is hydroxyl, C₁-C₁₂alkoxy or

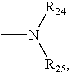

R₁₆ and R₁₇ are methyl groups or, together with the C atom to which they are attached, form a C₅-C₈cycloalkylidene ring which is unsubstituted or substituted from 1 to 3 times by C₁-C₄alkyl,
R₂₄ and R₂₅ independently of one another are hydrogen or C₁-C₁₂alkyl,
p is 1 or 2, and
q is 2, 3, 4, 5 or 6.

Also of particular interest is a composition containing at least one compound of the formula I in which at least two of the radicals R₂, R₃, R₄ and R₅ are hydrogen.

Of special interest is a composition containing at least one compound of the formula I in which R₃ and R₅ are hydrogen.

Of very special interest is composition containing at least one compound of the formula I in which

R₂ is C₁-C₄alkyl,
R₃ is hydrogen,
R₄ is C₁-C₄alkyl or, if R₆ is hydrogen, R₄ is additionally a radical of the formula III,
R₅ is hydrogen, and
R₁₆ and R₁₇, together with the C atom to which they are attached, form a cyclohexylidene ring.

The following compounds are examples of the benzofuran-2-one type which are particularly suitable in the composition of the present invention: 3-[4-(2-acetoxyethoxy)phenyl]-5,7-di-tertbutyl-benzofuran-2-one; 5,7-di-tert-butyl-3-[4-(2-stearoyloxyethoxy)phenyl]benzofuran-2-one; 3,3′-bis[5,7-di-tert-butyl-3-(4-[2-hydroxyethoxy]phenyl)benzofuran-2-one]; 5,7-di-tert-butyl-3-(4-ethoxyphenyl)benzofuran-2-one; 3-(4-acetoxy-3,5-dimethylphenyl)-5,7-di-tert-butylbenzofuran-2-one; 3-(3,5-dimethyl-4-pivaloyloxy-phenyl)-5,7-di-tert-butyl-benzofuran-2-one; 5,7-di-tert-butyl-3-phenylbenzofuran-2-one; 5,7-di-tert-butyl-3-(3,4-dimethylphenyl)-benzofuran-2-one; 5,7-di-tert-butyl-3-(2,3-dimethylphenyl)benzofuran-2-one.

Also of special interest is a composition containing at least one compound of the formula V

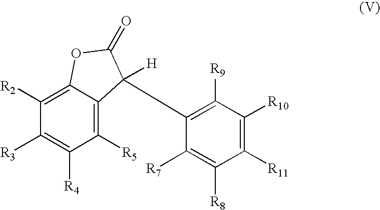

in which
R₂ is hydrogen or C₁-C₆alkyl,
R₃ is hydrogen,
R₄ is hydrogen or C₁-C₆alkyl,
R₅ is hydrogen,
R₇, R₈, R₉, R₁₀ and R₁₁, independently of one another are hydrogen, C₁-C₄alkyl or C₁-C₄alkoxy, with the proviso that at least two of the radicals R₇, R₈, R₉, R₁₀ or R₁₁ are hydrogen.

Very particular preference is given to a composition containing at least one compound of the formula Va or Vb

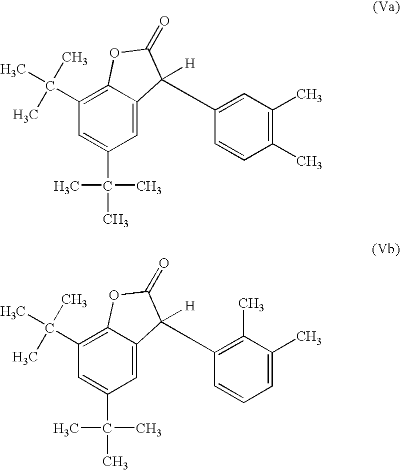

or a mixture of the two compounds of the formula Va and Vb.

Long chain N,N-dialkylhydroxylamine antioxidants useful in the composition of the present invention are those disclosed in U.S. Pat. No. 4,876,300, which is incorporated herein by reference.

The long chain N,N-dialkylhydroxylamine antioxidants useful in the composition of the present invention include those of formula (VI)

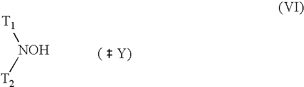

wherein T₁ and T₂ are independently alkyl of 6 to 36 carbon atoms, preferably 12-36 carbon atoms and most preferably 16-18 carbon atoms. Of particular interest is the long chain hydroxylamine for formula (VI) wherein T₁ and T₂ are the same and are a straight chain alkyl of 18 carbon atoms.

The hydroxylamine antioxidants in the present compositions and methods are, for example, N,N-dioctylhydroxylamine, N,N-dilaurylhydroxylamine, N,N-didodecylhydroxylamine, N ,N-ditetradecylhydroxylamine, N,N-dihexadecylhydroxylamine, N,N-dioctadecylhydroxylamine, N-hexadecyl-N-tetradecylhydroxylamine, N-hexadecyl-N-heptadecylhydroxylamine, N-hexadecyl-N-octadecylhydroxylamine, N-heptadecyl-N-octadecylhydroxylamine, N-methyl-N-octadecylhydroxylamine and N,N-di(hydrogenated tallow)hydroxylamine. Compounds of special interest are those where T₁ and T₂ are each dodecyl, tetradecyl, hexadecyl or octadecyl; or where T₁ is hexadecyl and T₂ is tetradecyl, heptadecyl or octadecyl; or where T₁ is heptadecyl and T₂ is octadecyl.

The long chain hydroxylamine antioxidant in the present invention may be for example the N,N-di(alkyl)hydroxylamine produced by the direct oxidation of N,N-di(hydrogenated tallow)amine (Irgastab® FS-042, Ciba Specialty Chemicals Corp.).

The substituted hydroxylamine antioxidants of the present invention are for example those described in U.S. Pat. Nos. 4,666,962, 4,666,963, 4,678,826, 4,753,972, 4,757,102, 4,760,179, 4,929,657, 5,057,563, 5,021,479, 5,045,583 and 5,185,448 the disclosures of which are hereby incorporated by reference. These include the Michael addition products from the reaction of the hydroxylamines of formula VI with any α,β-unsaturated ketone, ester, amide, or phosphonate; and also includes Mannich-type condensation products from the reaction of the hydroxylamines of formula VI with formaldehyde and secondary amines. Also included are O-alkenyl substituted analogues of the hydroxylamines as disclosed in U.S. Pat. No. 5,045,583. also includes non-hindered substituted hydroxylamines as disclosed in U.S. Pat. No. 5,185,448 and acyl derivatives of the unsubstituted hydroxylamine antioxidants for example such as those disclosed in U.S. Pat. No. 5,021,479.
The substituted hydroxylamines may be derivatives of the above-described hydroxylamines of formulae (VI) or hydroxylamines of the formula (VII)

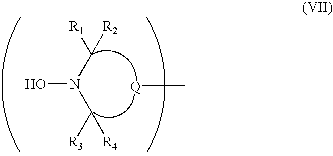

wherein
Q is a group forming a five- or six-membered ring; and
R₁, R₂, R₃ and R₄ are independently hydrogen, alkyl of 1 to 4 carbon atoms or phenyl, provided that if they are derivatives of hydroxylamines of formula (VII), that they are limited to derivatives of hydroxylamines as described in U.S. Pat. Nos. 5,185,448 and 5,235,056.
The present substituted hydroxylamines may be for example of the formula (VIII) or (IX)

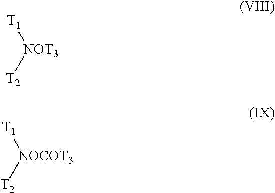

wherein
T₁ is straight or branched chain alkyl of 1 to 36 carbon atoms, cycloalkyl of 5 to 12 carbon atoms, aralkyl of 7 to 9 carbon atoms, or said aralkyl substituted by one or two alkyl of 1 to 12 carbon atoms or by one or two halogen atoms;
T₂ is hydrogen, or independently has the same meaning as T₁; and
T₃ is allyl, straight or branched chain alkyl of 1 to 36 carbon atoms, cycloalkyl of 5 to 18 carbon atoms, cycloalkenyl of 5 to 18 carbon atoms or a straight or branched chain alkyl of 1 to 4 carbon atoms substituted by phenyl or by phenyl substituted by one or two alkyl groups of 1 to 4 carbon atoms or by 1 or 2 halogen atoms.

The substituted hydroxylamines may be for example O-allyl-N,N-dioctadecylhydroxylamine or O-n-propyl-N,N-dioctadecylhydroxylamine or N,N-di(hydrogenated tallow)acetoxyamine.

The nitrones may be for example as described in U.S. Pat. No. 4,898,901, which is hereby incorporated by reference.

The nitrones of are for example of the formula (X)

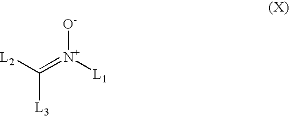

wherein
L₁ is straight or branched chain alkyl of 1 to 36 carbon atoms, cycloalkyl of 5 to 12 carbon atoms, aralkyl of 7 to 9 carbon atoms, or said aralkyl substituted by one or two alkyl of 1 to 12 carbon atoms or by one or two halogen atoms;
L₂ and L₃ are independently hydrogen, straight or branched chain alkyl of 1 to 36 carbon atoms, cycloalkyl of 5 to 12 carbon atoms, aralkyl of 7 to 9 carbon atoms, or said aralkyl substituted by one or two alkyl of 1 to 12 carbon atoms or by one or two halogen atoms;
   or L₁ and L₂ together form a five- or six-membered ring including the nitrogen atom.

The nitrones of may be the corresponding oxidation products of the unsubstituted hydroxylamines. That is to say, the nitrones may be nitrone analogues of the unsubstituted hydroxylamines. The nitrones may be for example, N-benzyl-α-phenylnitrone, N-ethyl-1-methylnitrone, N-octyl-α-heptyinitrone, N-lauryl-α-undecylnitrone, N-tetradecyl-α-tridcyinitrone, N-hexadecyl-α-pentadecylnitrone, N-octadecyl-α-heptadecylnitrone, N-hexadecyl-α-heptadecylnitrone, N-ocatadecyl-α-pentadecylnitrone, N-heptadecyl-α-heptadecylnitrone, N-octadecyl-α-hexadecylnitrone, N-methyl-a-heptadecylnitrone and the nitrone derived from N,N-di(hydrogenated tallow)hydroxylamine.

The amine oxides of are for example those disclosed in U.S. Pat. Nos. 5,081,300, 5,162,408, 5,844,029, 5,880,191 and 5,922,794, the relevant parts of each incorporated herein by reference.

The amine oxides are for example saturated tertiary amine oxides as represented by general formula (XI):

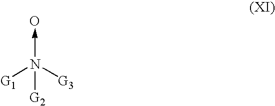

wherein
G₁ and G₂ are independently a straight or branched chain alkyl of 6 to 36 carbon atoms, aryl of 6 to 12 carbon atoms, aralkyl of 7 to 36 carbon atoms, alkaryl of 7 to 36 carbon atoms, cycloalkyl of 5 to 36 carbon atoms, alkcycloalkyl of 6 to 36 carbon atoms or cycloalkylalkyl of 6 to 36 carbon atoms;
G₃ is a straight or branched chain alkyl of 1 to 36 carbon atoms, aryl of 6 to 12 carbon atoms, aralkyl of 7 to 36 carbon atoms, alkaryl of 7 to 36 carbon atoms, cycloalkyl of 5 to 36 carbon atoms, alkcycloalkyl of 6 to 36 carbon atoms or cycloalkylalkyl of 6 to 36 carbon atoms; with the proviso that at least one of G₁, G₂ and G₃ contains a b carbonhydrogen bond; and
wherein said aryl groups may be substituted by one to three halogen, alkyl of 1 to 8 carbon atoms, alkoxy of 1 to 8 carbon atoms or combinations thereof; and
wherein said alkyl, aralkyl, alkaryl, cycloalkyl, alkcycloalkyl and cycloalkylalkyl groups may be interrupted by one to sixteen —O—, —S—, —SO—, —SO₂—, —COO—, —OCO—, —CO—, —NG₄-, —CONG₄- and —NG₄CO— groups, or wherein said alkyl, aralkyl, alkaryl, cycloalkyl, alkcycloalkyl and cycloalkylalkyl groups may be substituted by one to sixteen groups selected from —OG₄, —SG₄, —COOG₄, —OCOG₄, —COG₄, —N(G₄)₂, —CON(G₄)₂, —NG₄COG₄ and 5- and 6-membered rings containing the —C(CH₃)(CH₂Rₓ)NL(CH₂Rₓ)(CH₃)C— group or wherein said alkyl, aralkyl, alkaryl, cycloalkyl, alkcycloalkyl and cycloalkylalkyl groups are both interrupted and substituted by the groups mentioned above; and
wherein
G₄ is independently hydrogen or alkyl of 1 to 8 carbon atoms;
Rₓ is hydrogen or methyl;
L is hydrogen, hydroxy, C₁₋₃₀ straight or branched chain alkyl moiety, a —C(O)R moiety where R is a C₁₋₃₀ straight or branched chain alkyl group, or a —OR_{y} moiety; and
R_{y} is C₁₋₃₀ straight or branched chain alkyl, C₂-C₃₀ alkenyl, C₂-C₃₀ alkynyl, C₅-C₁₂ cycloalkyl, C₆-C₁₀ bicycloalkyl, C₅-C₈ cycloalkenyl, C₆-C₁₀ aryl, C₇-C₈ aralkyl, C₇-C₉ aralkyl substituted by alkyl or aryl, or —CO(D), where D is C₁-C₁₈ alkyl, C₁-C₁₈ alkoxy, phenyl, phenyl substituted by hydroxy, alkyl or alkoxy, or amino or amino mono- or di-substituted by alkyl or phenyl.

Examples of structures of formula (XI) are where G₁ and G₂ are independently benzyl or substituted benzyl. It is also possible for each of G₁, G₂, and G₃ to be the same residue. G₁ and G₂ may also independently be alkyl groups of 8 to 26 carbon atoms, for example alkyl groups of 10 to 26 carbon atoms. G₃ may be an alkyl group of 1 to 22 carbon atoms, for example methyl or substituted methyl. Also, the present amine oxides include those wherein G₁, G₂, and G₃ are the same alkyl groups of 6 to 36 carbon atoms. The aforementioned residues for G₁, G₂, and G₃ are, for instance, saturated hydrocarbon residues or saturated hydrocarbon residues containing at least one of the aforementioned —O—, —S—, —SO—, —CO₂—, —CO—, or —CON— moieties. Those skilled in the art will be able to envision other useful residues for each of G₁, G₂, and G₃ without detracting from the present invention.

The saturated amine oxides may also includes poly(amine oxides). By poly(amine oxides) is meant tertiary amine oxides containing at least two tertiary amine oxides per molecule. Illustrative poly(amine oxides), also called “poly(tertiary amine oxides)”, include the tertiary amine oxide analogues of aliphatic and alicyclic diamines such as, for example, 1,4-diaminobutane; 1,6-diaminohexane; 1,10-diaminodecane; and 1,4-diaminocyclohexane, and aromatic based diamines such as, for example, diamino anthraquinones and diaminoanisoles.

Also included are tertiary amine oxides derived from oligomers and polymers of the aforementioned diamines. Useful amine oxides also include amine oxides attached to polymers, for example, polyolefins, polyacrylates, polyesters, polyamides, polystyrenes, and the like. When the amine oxide is attached to a polymer, the average number of amine oxides per polymer can vary widely as not all polymer chains need to contain an amine oxide. All of the aforementioned amine oxides may optionally contain at least one —O—, —S—, —SO—, —CO₂—, —CO—, or —CONG₄- moiety. For instance, each tertiary amine oxide of the polymeric tertiary amine oxide may contain a C₁ residue.

Specific examples of preferred antioxidants of the present invention are one or more compounds selected from
i.) an N,N-di(alkyl)hydroxylamine produced by the direct oxidation of N,N-di(hydrogenated tallow)amine (Irgastab® FS-042),
ii.) O-allyl-N,N-dioctadecylhydroxylamine,
iii.) N-octadecyl-a-heptadecylnitrone, and
iv.) a di(C₁₆-C₁₈)alkyl methyl amine oxide, (Genox™ EP).

Irgastab® FS-042 is available from Ciba Specialty Chemicals. Genox™ EP is available from GE Specialty Chemicals. O-allyl-N,N-dioctadecylhydroxylamine is as prepared in Example 3 of U.S. Pat. No. 5,045,583. N-octadecyl-a-heptadecylnitrone is as prepared in Example 3 of U.S. Pat. No. 4,898,901.

The antioxidants of this invention are provided in compositions of this invention in a minor amount based on the weight of the edible organic substance, which amount is effective as an antioxidant, i.e. sufficient to stabilize, or retard the deterioration of, the edible organic substances to be stored and used to prepare foods in a normal and acceptable manner. The amount of antioxidant employed is generally any amount which may have a significant stabilizing effect. The amount of the compounds of this invention present may depend on the desired period of stability of the edible organic substance and the rate of deterioration of the edible organic substance. Thus, increased amounts of the compound of the present invention may be employed when an increased storage life of the edible organic substance before use is desired. Frequently, the compounds of the present invention will be provided in an amount of at least about 0.005%, preferably at least about 0.01%, by weight based on the weight of the edible organic substance up to a maximum of 5%, preferably up to about 1%. Concentrations of about 0.1 or more weight percent of the compounds of the present invention based on the edible organic substance are frequently employed in accordance with the invention. At concentrations in excess of about 5% by weight based on the weight of the edible organic substance, little benefit in increased stability is generally observed.

The presence of the compounds of the present invention usually does not materially affect the manner in which the edible organic substance is formulated or in which it is used to prepare foods. The compounds of the present invention are preferably uniformly admixed in the edible organic substance. The compounds of the present invention may be added at the time of food preparation or may be intimately premixed with the edible fat or fatty oils to stabilize them prior to food preparation.

It is often convenient to provide an edible fat or fatty oil composition in which the volume of the product can easily be handled, particularly when the composition must be transported for its use in food preparation. On the other hand, this invention is applicable to large food processing plants where large volumes of edible organic substance are stored and used in food preparation. The compounds of the present invention, due to their low toxicity and low concentrations which can be effectively employed, are especially suitable for stabilization of large volume doughs such as pastry, cake and biscuit premix such as are used in the baking industry. Also, use in other large scale food production plants such as pet food and other animal feeds are other applications where the compounds of the present invention are especially suitable.

A combination of antioxidants is frequently used in edible fats and fatty oils and foods containing them. The compounds of the present invention may be utilized in conjunction with other food antioxidants to obtain desirable combinations of properties of stability and carry-through. The other food antioxidants can be used in an amount of from about 0.01-0.1% by weight based on the weight of the edible organic substance. They may also be combined with other food additives such as emulsifiers, suspension agents and colorings to provide the desired qualities in the final food product. Examples of such additional food antioxidants include the following:
1. Phenolics such as BHA and BHT.
2. Tocopherols, for example α-tocopherol, β-tocopherol, γ-tocopherol, δ-tocopherol and mixtures thereof (Vitamin E).
3. Benzylphosphonates, for example dimethyl-2,5-di-tert-butyl-4-hydroxybenzylphosphonate, diethyl-3,5-di-tert-butyl-4-hydroxybenzylphosphonate, dioctadecyl-3,5-di-tert-butyl-4-hydroxybenzylphosphonate, dioctadecyl-5-tert-butyl-4-hydroxy-3-methylbenzylphosphonate, the calcium salt of the monoethyl ester of 3,5-di-tert-butyl-4-hydroxybenzylphosphonic acid.
4. Esters of b-(3,5-di-tert-butyl-4-hydroxyphenyl)propionic acid with mono- or polyhydric alcohols, e.g. with methanol, ethanol, n-octanol, i-octanol, octadecanol, 1,6-hexanediol, 1,9-nonanediol, ethylene glycol, 1,2-propanediol, neopentyl glycol, thiodiethylene glycol, diethylene glycol, triethylene glycol, pentaerythritol, tris(hydroxyethyl)isocyanurate, N,N′-bis(hydroxyethyl)oxamide, 3-thiaundecanol, 3-thiapentadecanol, trimethylhexanediol, trimethylolpropane, 4-hydroxymethyl-1-phospha-2,6,7-trioxabicyclo[2.2.2]octane.
5. Esters of b-(5-tert-butyl-4-hydroxy-3-methylphenyl)propionic acid with mono- or polyhydric alcohols, e.g. with methanol, ethanol, n-octanol, i-octanol, octadecanol, 1,6-hexanediol, 1,9-nonanediol, ethylene glycol, 1,2-propanediol, neopentyl glycol, thiodiethylene glycol, diethylene glycol, triethylene glycol, pentaerythritol, tris(hydroxyethyl)isocyanurate, N,N′-bis(hydroxyethyl)oxamide, 3-thiaundecanol, 3-thiapentadecanol, trimethylhexanediol, trimethylolpropane, 4-hydroxymethyl-1-phospha-2,6,7-trioxabicyclo[2.2.2]octane.
6. Esters of b-(3,5-dicyclohexyl-4-hydroxyphenyl)propionic acid with mono- or polyhydric alcohols, e.g. with methanol, ethanol, octanol, octadecanol, 1,6-hexanediol, 1,9-nonanediol, ethylene glycol, 1,2-propanediol, neopentyl glycol, thiodiethylene glycol, diethylene glycol, triethylene glycol, pentaerythritol, tris(hydroxyethyl)isocyanurate, N,N′-bis(hydroxyethyl)oxamide, 3-thiaundecanol, 3-thiapentadecanol, trimethylhexanediol, trimethylolpropane, 4-hydroxymethyl-1-phospha-2,6,7-trioxabicyclo[2.2.2]octane.
7. Esters of 3,5-di-tert-butyl-4-hydroxyphenyl acetic acid with mono- or polyhydric alcohols, e.g. with methanol, ethanol, octanol, octadecanol, 1,6-hexanediol, 1,9-nonanediol, ethylene glycol, 1,2-propanediol, neopentyl glycol, thiodiethylene glycol, diethylene glycol, triethylene glycol, pentaerythritol, tris(hydroxyethyl)isocyanurate, N,N′-bis(hydroxyethyl)oxamide, 3-thiaundecanol, 3-thiapentadecanol, trimethylhexanediol, trimethylolpropane, 4-hydroxymethyl-1-phospha-2,6,7-trioxabicyclo[2.2.2]octane.
8. Ascorbic acid (vitamin C)
9. Phosphites and phosphonites, for example triphenyl phosphite, diphenyl alkyl phosphites, phenyl dialkyl phosphites, tris(nonylphenyl)phosphite, trilauryl phosphite, trioctadecyl phosphite, dialkylpentaerythritol diphosphites, distearyl pentaerythritol diphosphite, tris(2,4-di-tert-butylphenyl)phosphite, diisodecyl pentaerythritol diphosphite, bis(2,4-di-tert-butylphenyl)pentaerythritol diphosphite (Ultranox® 626, GE Chemicals, formula (D)), bis(2,6-di-tert-butyl-4-methylphenyl)-pentaerythritol diphosphite, diisodecyloxypentaerythritol diphosphite, bis(2,4-di-tert-butyl-6-methylphenyl)pentaerythritol diphosphite, bis(2,4,6-tris(tert-butylphenyl)pentaerythritol diphosphite, tristearyl sorbitol triphosphite, tetrakis(2,4-di-tert-butylphenyl) 4,4′-biphenylene diphosphonite (Irgafos® P-EPQ, Ciba Specialty Chemicals Corp., formula (H)), 6-isooctyloxy-2,4,8,10-tetra-tert-butyldibenzo[d,f][1,3,2]dioxaphosphepin, 6-fluoro-2,4,8,10-tetra-tert-butyl-[2-methyldibenzo[d,g][1,3,2]dioxaphosphocin, bis(2,4-di-tert-butyl-6-methylphenyl)methyl phosphite, bis(2,4-di-tert-butyl-6-methylphenyl)ethyl phosphite, 2,2′,2″-nitrilo[triethyltris(3,3′,5,5′-tetratert-butyl-1,1′-biphenyl-2,2′-diyl)phosphite], 2-ethylhexyl(3,3′,5,5′-tetra-tert-butyl-1,1′-biphenyl-2,2′-diyl)phosphite.
10. Rosemary Extract
The following examples are for illustrative purposes only and are not to be construed to limit the scope of the instant invention in any manner whatsoever.

### EXPERIMENTAL METHODS

Corn oil (3 g) stripped of natural tocopherols was oxidized in stoppered 50 ml Erlenmeyer flasks in a shaker oven (Lab-Line Instrument, Inc, Melrose Park, Ill.). Lipid oxidation was followed by measuring perioxide values colorimetrically, and hexanal by static headspace gas chromatography. Periodie values were determined by the ferric thiocyanate method (Chapman, R. A.; Mackay, K. The estimation of perioxides in fats and oils by the ferric thiocyanate method. J. Am. Oil Chem. Soc. 1949, 26, 360-363), modified for safety reasons using choloform:methanol (3:1, v/v) instead of benzene:methanol as solvent. Propanol was determined by static headspace gas chromatography (Frankel, E. N. Formation of headspace volatiles by thermal decomposition of oxidized fish oils vs. oxidized vegetable oils. J. Am. Oil. Chem. Soc. 1993, 70, 767-772). Aliquots of oil samples (0.20 g) were weighed into 22-ml headspace vials, sealed and equilibrated at 80° C. for 10 min in an HS-40 headspace autosampler. An aliquot of the headspace was then injected in an autosystem gas chromatograph (Perkin-Elmer, Norwalk, Conn.) equipped with a capillary DB-1701 column, 30 m long, 0.32 mm id, and 1 μm film thickness (J&W Scientific, Folsom, Calif.). The injector and detector temperatures were 180 and 200° C., respectively. The oven temperature was controlled isothermally at 65° C. Hexanal was quantified by using standard solutions of known concentrations. All analyses were carried out in duplicate.

The activity of the antioxidants was evaluated by determining peroxide values and hexanal using corn oil stripped of natural tocopherols after oxidation at 50 and 60° C. Peroxide values measurements are classical measurements of hydroperoxides that are generally accepted in antioxidant evaluations. This measure is useful at relatively low levels of oxidation and the temperatures used in this study which are sufficiently mild so that hydroperoxides are not markedly decomposed. Hexanal determinations are measurements of hydroperoxide decomposition which may be more closely related to flavor deterioration and rancidity than peroxide values. Antioxidants in accordance with the present invention that were tested were (1) 042—an N,N-di(alkyl)hydroxylamine produced by the direct oxidation of N,N-di(hydrogenated tallow)amine (commercially available from Ciba Specialty Chemicals Corporation Irgastab® FS-042) and Irganox® HP-136—3-(3,4-dimethylphenyl)-5,7-di-tertbutyl-benzofuran-2-one. The antioxidants were tested at 100 and 200 ppm and compared with the commercial antioxidants BHA, BHT and TBHQ and commercial natural antioxidants tocopherol mixtures at the same concentration and a rosemary extract at 250 and 500 ppm.

For the evaluations at 50° C., an endpoint was selected of 8 days for both peroxide values and hexanal contents during the propagation stage where the rate of oxidation is accelerated. The results of the evaluations are shown in Tables 1-2.

For the evaluations at 60° C., an endpoint was selected of 3 days for peroxide values and 4 days for hexanal contents during the propagation stage where the rate of oxidation is accelerated. The results of the evaluations are shown in Tables 3-4.

TABLE 1

| | Peroxide value (meq/kg) | | | | Hexanal (x1000 mmol/kg) | | |
|---|---|---|---|---|---|---|---|
| Oil samples | Day 2 | Day 4 | Day 8 | Day 10 | Day 4 | Day 8 | Day 10 |
| BHA 100 ppm | 9.2 | 21.0 | 55.5 | 77.0 | 18.0 | 18.3 | 16.3 |
| BHA 200 ppm | 9.7 | 21.2 | 53.5 | 72.2 | 16.2 | 17.1 | 21.1 |
| BHT 100 ppm | 7.5 | 16.8 | 43.5 | 62.2 | 13.2 | 22.9 | 20.2 |
| BHT 200 ppm | 4.8 | 10.3 | 3.3 | 32.4 | 8.6 | 17.2 | 15.1 |
| TBHQ 100 ppm | 0.7 | 0.7 | 1.6 | 2.3 | 7.7 | 8.7 | 7.0 |
| TBHQ 200 ppm | 0.5 | 1.2 | 1.6 | 2.1 | 7.5 | 11.7 | 17.8 |
| Tocopherols 100 ppm | 10.1 | 24.4 | 58.7 | 84.1 | 12.1 | 40.0 | 75.9 |
| Tocopherols 200 ppm | 13.5 | 28.1 | 79.9 | 101.9 | 16.5 | 19.6 | 75.3 |
| Rosemary 250 ppm | 2.2 | 4.2 | 8.5 | 10.7 | 9.5 | 29.3 | 53.6 |
| Rosemary 500 ppm | 2.0 | 4.1 | 7.7 | 10.4 | 7.0 | 143.4 | 286.6 |
| Irgastab ® FS-042 100 ppm | 1.0 | 1.9 | 4.1 | 14.3 | 4.3 | 76.4 | 110.0 |
| Irgastab ® FS-042 200 ppm | 1.0 | 1.7 | 3.5 | 8.0 | 3.9 | 13.7 | 21.0 |
| Irganox ® HP-136 100 ppm | 1.9 | 6.1 | 20.2 | 47.1 | 6.0 | 37.9 | 210.8 |
| Irganox ® HP-136 200 ppm | 2.4 | 5.1 | 16.4 | 86.1 | 14.5 | 14.5 | 97.3 |

TABLE 2

| | Inhibition of Peroxide Values (%) | | | | Inhibition of Hexanal (%) | | |
|---|---|---|---|---|---|---|---|
| Oil samples | Day 2 | Day 4 | Day 8 | Day 10 | Day 4 | Day 8 | Day 10 |
| BHA 100 ppm | 1.3 | 6.8 | 20.4 | 31.6 | −29.4 | 77.2 | 94.3 |
| BHA 200 ppm | −6.1 | −0.6 | 22.0 | 29.6 | 26.2 | 78.8 | 81.9 |
| BHT 100 ppm | 19.0 | 25.6 | 37.7 | 44.7 | 5.4 | 71.4 | 93.0 |
| BHT 200 ppm | 47.6 | 51.1 | 95.2 | 68.4 | 60.9 | 78.7 | 87.1 |
| TBHQ 100 ppm | 92.1 | 97.0 | 97.7 | 98.0 | 44.5 | 89.2 | 97.6 |
| TBHQ 200 ppm | 94.8 | 94.4 | 97.6 | 97.9 | 65.9 | 85.5 | 84.7 |
| Tocopherols 100 ppm | −8.2 | −8.1 | 15.8 | 25.2 | 13.2 | 50.1 | 73.7 |
| Tocopherols 200 ppm | −47.7 | −33.0 | −16.5 | 0.6 | 25.1 | 75.7 | 35.5 |
| Rosemary 250 ppm | 76.4 | 79.9 | 87.6 | 89.5 | 56.7 | 63.7 | 54.0 |
| Rosemary 500 ppm | 78.7 | 82.0 | 89.0 | 90.8 | 49.9 | −78.9 | 0.6 |
| Irgastab ® FS-042 100 ppm | 89.3 | 91.6 | 94.1 | 51.0 | 65.8 | 38.9 | 61.1 |
| Irgastab ® FS-042 200 ppm | 89.0 | 91.9 | 94.9 | 92.2 | 69.0 | 89.1 | 81.0 |
| Irganox ® HP-136 100 ppm | 79.1 | 73.1 | 71.0 | 58.2 | 56.8 | 52.8 | 26.9 |
| Irganox ® HP-136 200 ppm | 74.2 | 75.9 | 76.2 | 16.0 | 33.9 | 82.0 | 16.6 |

TABLE 3

| | Peroxide value (meq/kg) | | | | Hexanal (x1000 mmol/kg) | | |
|---|---|---|---|---|---|---|---|
| Oil samples | Day 1 | Day 2 | Day 3 | Day 4 | Day 2 | Day 3 | Day 4 |
| BHA 100 ppm | 9.6 | 25.6 | 52.0 | 84.6 | 21.5 | 32.8 | 54.6 |
| BHA 200 ppm | 7.9 | 20.4 | 38.1 | 61.2 | 18.9 | 18.3 | 30.2 |
| BHT 100 ppm | 5.9 | 14.8 | 26.6 | 45.1 | 11.6 | 14.8 | 82.6 |
| BHT 200 ppm | 4.7 | 11.7 | 21.6 | 33.2 | 14.1 | 15.4 | 12.7 |
| TBHQ 100 ppm | 0.4 | 1.2 | 1.2 | 1.7 | 7.9 | 7.7 | 16.0 |
| TBHQ 200 ppm | 0.0 | 0.2 | 0.9 | 1.1 | 7.5 | 10.1 | 12.4 |
| Tocopherols 100 ppm | 9.4 | 22.9 | 40.1 | 55.1 | 13.9 | 21.8 | 238.8 |
| Tocopherols 200 ppm | 9.2 | 22.9 | 40.8 | 58.0 | 13.8 | 14.8 | 17.8 |
| Rosemary 250 ppm | 1.2 | 3.1 | 5.5 | 7.8 | 11.5 | 26.3 | 120.3 |
| Rosemary 500 ppm | 1.7 | 3.5 | 4.8 | 6.9 | 7.6 | 12.4 | 19.9 |
| Irgastab ® FS-042 100 ppm | 1.5 | 2.2 | 2.7 | 3.2 | 7.5 | 4.2 | 5.9 |
| Irgastab ® FS-042 200 ppm | 0.7 | 1.6 | 2.4 | 4.0 | 12.6 | 20.9 | 34.4 |
| Irganox ® HP-136 100 ppm | 6.1 | 5.3 | 9.5 | 216.4 | 8.9 | 10.3 | 9.5 |
| Irganox ® HP-136 200 ppm | 6.0 | 4.1 | 7.4 | 51.6 | 13.0 | 33.6 | 141.7 |

TABLE 4

| | Inhibition of Peroxide Values (%) | | | | Inhibition of Hexanal (%) | | |
|---|---|---|---|---|---|---|---|
| Oil samples | Day 1 | Day 2 | Day 3 | Day 4 | Day 2 | Day 3 | Day 4 |
| BHA 100 ppm | −15.7 | −13.0 | −11.1 | 4.6 | −29.3 | 18.3 | 72.8 |
| BHA 200 ppm | 11.2 | 18.9 | 36.7 | 42.6 | 45.3 | 82.3 | 81.9 |
| BHT 100 ppm | 29.5 | 34.6 | 43.3 | 48.9 | 30.9 | 62.0 | 67.0 |
| BHT 200 ppm | 47.0 | 53.9 | 64.3 | 68.8 | 53.2 | 84.2 | 96.1 |
| TBHQ 100 ppm | 94.8 | 94.8 | 97.4 | 98.1 | 51.6 | 79.0 | 90.3 |
| TBHQ 200 ppm | 103.3 | 99.2 | 98.4 | 99.0 | 73.6 | 91.8 | 96.7 |
| Tocopherols 100 ppm | −12.2 | −1.0 | 14.5 | 37.1 | 16.6 | 45.8 | −45.2 |
| Tocopherols 200 ppm | −6.0 | 7.7 | 31.8 | 45.5 | 56.0 | 85.5 | 94.5 |
| Rosemary 250 ppm | 86.2 | 87.5 | 90.8 | 92.7 | 62.0 | 69.2 | 47.4 |
| Rosemary 500 ppm | 79.3 | 84.7 | 89.8 | 92.1 | 54.1 | 65.2 | 87.9 |
| Irgastab ® FS-042 100 ppm | 82.3 | 90.3 | 94.2 | 96.5 | 57.7 | 91.7 | 98.1 |
| Irgastab ® FS-042 200 ppm | 93.2 | 94.0 | 96.2 | 96.3 | 44.2 | 71.2 | 84.4 |
| Irganox ® HP-136 100 ppm | 26.4 | 76.5 | 79.5 | −135.5 | 49.9 | 79.4 | 97.0 |
| Irganox ® HP-136 200 ppm | 40.5 | 85.0 | 88.2 | 52.3 | 42.4 | 53.6 | 35.9 |

What is claimed is:

1. A composition of matter normally subject to oxidative deterioration comprising an edible organic substance normally subject to oxidative deterioration and a minor amount effective as an antioxidant of one or more compounds selected from the group consisting of
(ii) a long chain N,N-dialkylhydroxylamine of formula (VI) 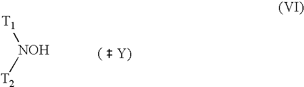
wherein T₁ and T₂ are independently straight or branched chain alkyl of 6 to 36 carbon atoms;
(iii) substituted hydroxylamines may be for example of the formula (VIII) or (IX) 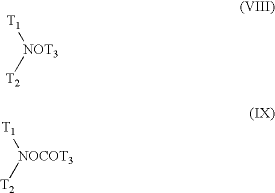
wherein
T₁ is straight or branched chain alkyl of 1 to 36 carbon atoms, cycloalkyl of 5 to 12 carbon atoms, aralkyl of 7 to 9 carbon atoms, or said aralkyl substituted by one or two alkyl of 1 to 12 carbon atoms or by one or two halogen atoms;
T₂ is hydrogen, or independently has the same meaning as T₁; and
T₃ is allyl, straight or branched chain alkyl of 1 to 36 carbon atoms, cycloalkyl of 5 to 18 carbon atoms, cycloalkenyl of 5 to 18 carbon atoms or a straight or branched chain alkyl of 1 to 4 carbon atoms substituted by phenyl or by phenyl substituted by one or two alkyl groups of 1 to 4 carbon atoms or by 1 or 2 halogen atoms;
(iv) nitrones of the formula (X) 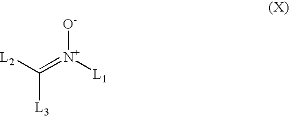
wherein
L₁ is straight or branched chain alkyl of 1 to 36 carbon atoms, cycloalkyl of 5 to 12 carbon atoms, aralkyl of 7 to 9 carbon atoms, or said aralkyl substituted by one or two alkyl of 1 to 12 carbon atoms or by one or two halogen atoms;
L₂ and L₃ are independently hydrogen, straight or branched chain alkyl of 1 to 36 carbon atoms, cycloalkyl of 5 to 12 carbon atoms, aralkyl of 7 to 9 carbon atoms, or said aralkyl substituted by one or two alkyl of 1 to 12 carbon atoms or by one or two halogen atoms;
or L₁ and L₂ together form a five- or six-membered ring including the nitrogen atom; and
(v) amine oxides are for example saturated tertiary amine oxides as represented by general formula (XI): 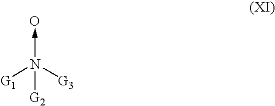
wherein
G₁ and G₂ are independently a straight or branched chain alkyl of 6 to 36 carbon atoms, aryl of 6 to 12 carbon atoms, aralkyl of 7 to 36 carbon atoms, alkaryl of 7 to 36 carbon atoms, cycloalkyl of 5 to 36 carbon atoms, alkcycloalkyl of 6 to 36 carbon atoms or cycloalkylalkyl of 6 to 36 carbon atoms;
G₃ is a straight or branched chain alkyl of 1 to 36 carbon atoms, aryl of 6 to 12 carbon atoms, aralkyl of 7 to 36 carbon atoms, alkaryl of 7 to 36 carbon atoms, cycloalkyl of 5 to 36 carbon atoms, alkcycloalkyl of 6 to 36 carbon atoms or cycloalkylalkyl of 6 to 36 carbon atoms; with the proviso that at least one of G₁, G₂ and G₃ contains a b carbonhydrogen bond; and
wherein said aryl groups may be substituted by one to three halogen, alkyl of 1 to 8 carbon atoms, alkoxy of 1 to 8 carbon atoms or combinations thereof; and
wherein said alkyl, aralkyl, alkaryl, cycloalkyl, alkcycloalkyl and cycloalkylalkyl groups may be interrupted by one to sixteen —O—, —S—, —SO—, —SO₂—, —COO—, —OCO—, —CO—, —NG₄-, —CONG₄- and —NG₄CO— groups, or wherein said alkyl, aralkyl, alkaryl, cycloalkyl, alkcycloalkyl and cycloalkylalkyl groups may be substituted by one to sixteen groups selected from —OG₄, —SG₄, —COOG₄, —OCOG₄, —COG₄, —N(G₄)₂, —CON(G₄)₂, —NG₄COG₄ and 5- and 6-membered rings containing the —C(CH₃)(CH₂Rₓ)NL(CH₂Rₓ)(CH₃)C— group or wherein said alkyl, aralkyl, alkaryl, cycloalkyl, alkcycloalkyl and cycloalkylalkyl groups are both interrupted and substituted by the groups mentioned above; and
wherein
G₄ is independently hydrogen or alkyl of 1 to 8 carbon atoms;
Rₓ is hydrogen or methyl;
L is hydrogen, hydroxy, C₁₋₃₀ straight or branched chain alkyl moiety, a —C(O)R moiety where R is a C₁₋₃₀ straight or branched chain alkyl group, or a —OR_{y} moiety; and
R_{y} is C₁₋₃₀ straight or branched chain alkyl, C₂-C₃₀ alkenyl, C₂-C₃₀ alkynyl, C₅-C₁₂ cycloalkyl, C₆-C₁₀ bicycloalkyl, C₅-C₈ cycloalkenyl, C₆-C₁₀ aryl, C₇-C₈ aralkyl, C₇-C₈ aralkyl substituted by alkyl or aryl, or —CO(D), where D is C₁-C₁₈ alkyl, C₁-C₁₈ alkoxy, phenyl, phenyl substituted by hydroxy, alkyl or alkoxy, or amino or amino mono- or di-substituted by alkyl or phenyl;
wherein the edible organic substance is a food containing fatty acid glycerides, edible fats and fatty oils; and said edible organic substance is selected from the group consisting of potato flakes, bakery products, meat emulsions, precooked cereals, instant noodles, soybean milk, chicken products, sausage, mayonnaise, margarine, frozen fish, frozen pizza, cheese, pet food and animal feed.

2. The compositions of claim 1 wherein the long chain hydroxylamine is a compound of the formula (VI) wherein T₁ and T₂ are independently selected from a straight or branched chain alkyl of 12-36 carbon atoms.

3. The composition of claim 1 wherein the long chain hydroxylamine is a compound of the formula (VI) wherein T₁ and T₂ are independently selected from a straight or branched chain alkyl of 16-18 carbon atoms.

4. The composition of claim 1 wherein the long chain hydroxylamine is a compound of formula (VI) wherein T₁ and T₂ are the same and are a straight chain alkyl of 18 carbon atoms.

5. The composition of claim 1 wherein the substituted hydroxylamine is at least one compound selected from O-allyl-N,N-dioctadecylhydroxylamine and O-n-propyl-N,N-dioctadecylhydroxylamine or N,N-di(hydrogenated tallow)acetoxyamine.

6. The composition of claim 1 wherein the nitrone is at least one compound selected from the group consisting of N-benzyl-α-phenylnitrone, N-ethyl-α-methylnitrone, N-octyl-α-heptylnitrone, N-lauryl-α-undecylnitrone, N-tetradecyl-α-tridcylnitrone, N-hexadecyl-α-pentadecylnitrone, N-octadecyl-α-heptadecylnitrone, N-hexadecyl-α-heptadecylnitrone, N-ocatadecyl-α-pentadecylnitrone, N-heptadecyl-α-heptadecylnitrone, N-octadecyl-α-hexadecylnitrone, N-methyl-α-heptadecylnitrone and the nitrone derived from N,N-di(hydrogenated tallow)hydroxylamine.

7. The composition of claim 1 wherein the amine oxide is a trialkyl amine oxide.

8. The composition of claim 1 wherein the amine oxide is tri(C₁₂-C₁₄) amine oxide.

9. The composition of claim 1 wherein the amine oxide is di(C₁₂-C₁₄) methyl amine oxide.

10. The composition of claim 1 wherein the amine oxide is tri(C₁₆-C₁₈) amine oxide.

11. The composition of claim 1 wherein the antioxidant is present in an amount of from about 0.005% by weight to about 5% by weight, based on the weight of the edible organic substance.

12. The composition of claim 1 wherein the antioxidant is present in an amount of from about 0.01% by weight to about 1% by weight, based on the weight of the edible organic substance.

13. The composition of claim 1 wherein the composition further comprises additional food additives selected from food antioxidants in addition to those specified in claim 1, emulsifiers, suspension agent and colorings.

14. The composition of claim 1 wherein the composition further comprises food antioxidants selected from the group consisting of butylated hydroxytoluene, butylated hydroxyanisole, tocopherol, ascorbic acid, benzylphosphonates, esters of b-(3,5-di-tert-butyl-4-hydroxyphenyl)propionic acid with mono- or polyhydric alcohols, esters of b-(5-tert-butyl-4-hydroxy-3-methylphenyl)propionic acid with mono- or polyhydric alcohols, esters of b-(3,5-dicyclohexyl-4-hydroxyphenyl)propionic acid with mono- or polyhydric alcohols, esters of 3,5-di-tert-butyl-4-hydroxyphenyl acetic acid with mono- or polyhydric alcohols, phosphites and phosphonites.

15. The composition of claim 1 wherein the antioxidant is one or more compounds selected from the group consisting of
i.) an N,N-di(alkyl)hydroxylamine produced by the direct oxidation of N,N-di(hydrogenated tallow)amine,
ii.) O-allyl-N,N-dioctadecylhydroxylamine,
iii.) N-octadecyl-a-heptadecylnitrone, and
iv.) a di(C₁₆-C₁₈)alkyl methyl amine oxide.
